(19) United States
(12) Patent Application Publication
(10) Pub. No.: US 2008/0186888 A1
(43) Pub. Date: Aug. 7, 2008

(54) Apparatus and method for home address recognition in mobile communication system

(75) Inventors: Tae-Hyoun Kim, Suwon-si (KR); Hyo-Soon Park, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 12/068,168

(22) Filed: Feb. 4, 2008

(30) Foreign Application Priority Data
Feb. 5, 2007 (KR) 2007-0011506

(51) Int. Cl. H04B 7/00

(52) U.S. Cl. 370/310

(57) ABSTRACT

An apparatus and method for home address recognition in a mobile communication system is disclosed. A method for transmitting a Home Address (HoA) of a Mobile Node (MN) in a mobile communication system includes receiving an advertisement message in the MN; acquiring a network prefix from the advertisement message; checking whether a situation of the MN is consistent with a first situation; creating a first address if the situation is consistent with the first situation; and transmitting a message comprising the first address, a second address, and information for notification of inclusion of the second address to a network.

### CROSS-REFERENCE TO RELATED PATENT APPLICATION

This application claims the benefit under 35 U.S.C. § 119(a) of Korean Patent Application No. 2007-11506, filed Feb. 5, 2007, in the Korean Intellectual Property Office, the entire disclosure of which is hereby incorporated by reference.

### BACKGROUND OF THE INVENTION

1. Field of the Invention

The present invention relates to an apparatus and method for home address recognition. More particularly, the present invention relates to an apparatus and method for home address recognition in a mobile communication system.

2. Description of the Related Art

FIG. 1 is a diagram illustrating a network architecture of a conventional 3GPP Long Time Evolution (LTE) communication system.

In FIG. 1, the 3GPP LTE communication system is an advanced next-generation communication system capable of providing a high-speed data service at a low cost, irrespective of time and space, by improving the low transmit rate and the high cost of a data service that is provided by an existing 3GPP mobile communication system.

The 3GPP LTE communication system provides a network optimized data transmission that provides a high-efficient spectrum use (5 bits/Hz), a high throughput (100 Mbps/20 MHz), a short transmission delay (5 ms or less), a scalable Radio Frequency (RF) architecture (a bandwidth scalability of 1.25 MHz to 20 MHz), and a simple access network architecture (2-tier architecture) on the basis of Frequency Division Duplex (FDD) Orthogonal Frequency Division Multiple Access (OFDMA) and Multi-In Multi-Out (MIMO) technologies.

An AGW 110 performs the main functions of packet forwarding, header compression, encryption, mobility management, paging and session control, charging, and monitoring a specific function of a User Equipment (UE). The AGW also broadcasts an advertisement message. That is, the AGW 110 performs a function of an access router.

An evolved Node-B (eNB) 120 performs Automatic Repeat reQuest (ARQ), Hybrid ARQ (HARQ), handoff control, radio resource control, Media Access Control (MAC) scheduling, and Protocol Description Unit (PDU) control functions.

An LTE System Manager (LSM) performs a function of operating and managing the 3GPP LTE communication system.

FIG. 2 is a ladder diagram illustrating a conventional binding update process.

In FIG. 2, if mobile IPv6 is applied to a 3GPP LTE communication system, an AGW 220 cannot recognize an HoA of an MN 210 because mobile IPv6 signaling messages (binding update and binding acknowledgement messages) are encrypted with IPSec between a Home Agent (HA) 230 and the MN 210.

The AGW 220 can manage a Care-of Address (CoA) created after the MN 210 moves to a new area or is booted, but cannot manage an HoA (step a). However, the AGW 220 cannot reflect the CoA in charging and policing for the MN 210 because the CoA is not a unique address.

Thus, there is a drawback that the AGW 220 cannot properly perform policing and charging functions for the MN 210 (step b). Accordingly, there is a need for an improved solution to the problem whereby policing and charging functions for a Mobile Node (MN) are not applied because an Access GateWay (AGW) does not decrypt a binding-update related packet encrypted with Internet Protocol Security (IPSec), and thus, does not acquire a Home Address (HoA) of the MN when Mobile Internet Protocol version 6 (MIPv6) is applied in a 3rd-Generation Partnership Project (3GPP) Long Time Evolution (LTE) communication system.

### SUMMARY OF THE INVENTION

Exemplary embodiments of the present invention address at least the above problems and/or disadvantages and to provide at least the advantages below. Accordingly, an aspect of exemplary embodiments of the present invention is to provide an apparatus and method for home address recognition in a mobile communication system.

Another aspect of exemplary embodiments of the present invention is to provide an apparatus and method for home address recognition in a mobile communication system, enabling an AGW to smoothly recognize an HoA of an MN using a duplicated address detection operation during a binding update process, thereby enabling the AGW to perform policing and charging functions for the MN when mobile IPv6 is applied in a mobile communication system.

According to an aspect of exemplary embodiments of the present invention, there is provided a method for transmitting a Home Address (HoA) of a Mobile Node (MN) in a mobile communication system. The method comprises receiving an advertisement message in the MN; acquiring a network prefix from the advertisement message; checking whether a situation of the MN is consistent with a first situation; creating a first address if the situation is consistent with the first situation; and transmitting a message comprising the first address, a second address, and information for notification of inclusion of the second address to a network.

According to another aspect of exemplary embodiments of the present invention, there is provided an MN for transmitting an HoA in a mobile communication system. The MN comprises a communication module, a controller, and a storage unit. The communication module communicates with another node. The controller receives an advertisement message through the communication module, acquires a network prefix, checks whether a situation of the MN is consistent with a first situation, creates a first address if the situation is consistent with the first situation, and then transmits a message comprising the first address, a second address, and information for notification of inclusion of the second address to a network. The storage unit stores the first address and the second address and provides a work space to the controller.

According to a further aspect of exemplary embodiments of the present invention, there is provided a method for acquiring an HoA in an AGW in a mobile communication system. The method comprises receiving a message from an MN; acquiring a first address and a second address from the message if discovering information for notification of inclusion of the second address in the message; and creating a binding cache mapping the first address and the second address.

According to another aspect of exemplary embodiments of the present invention, there is provided an AGW for acquiring an HoA in a mobile communication system. The AGW comprises a communication module, a controller, and a storage unit. The communication module communicates with another node. The controller receives a message from an MN through the communication module, acquires a first address and a second address from the message if discovering information for notification of inclusion of the second address from the message, and creates a binding cache mapping the first address and the second address. The storage unit stores the binding cache and provides a work space to the controller.

According another aspect of exemplary embodiments of the present invention, there is provided a system for transmitting/receiving an HoA in a mobile communication system. The system comprises an MN and an AGW. The MN receives an advertisement message, acquires a network prefix, checks whether a present situation is consistent with a first situation, creates a first address if the present situation is consistent with the first situation, and transmits a message comprising the first address, a second address, and information for notification of inclusion of the second address. The AGW receives the message, acquires the first address and the second address if discovering the information for the notification of the inclusion of the second address in the message, and creates a binding cache mapping the first address and the second address.

### BRIEF DESCRIPTION OF THE DRAWINGS

The above and other objects, features and advantages of the present invention will become more apparent from the following detailed description when taken in conjunction with the accompanying drawings, in which:

FIG. 1 is a diagram illustrating a network architecture of a conventional 3GPP LTE communication system;

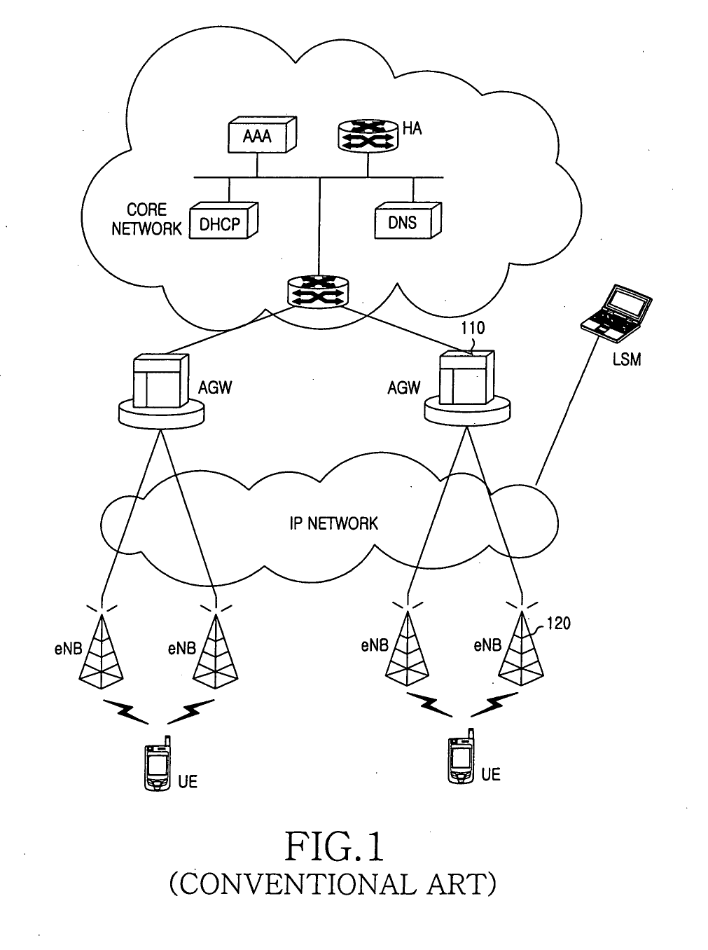

FIG. 2 is a ladder diagram illustrating a conventional binding update process;

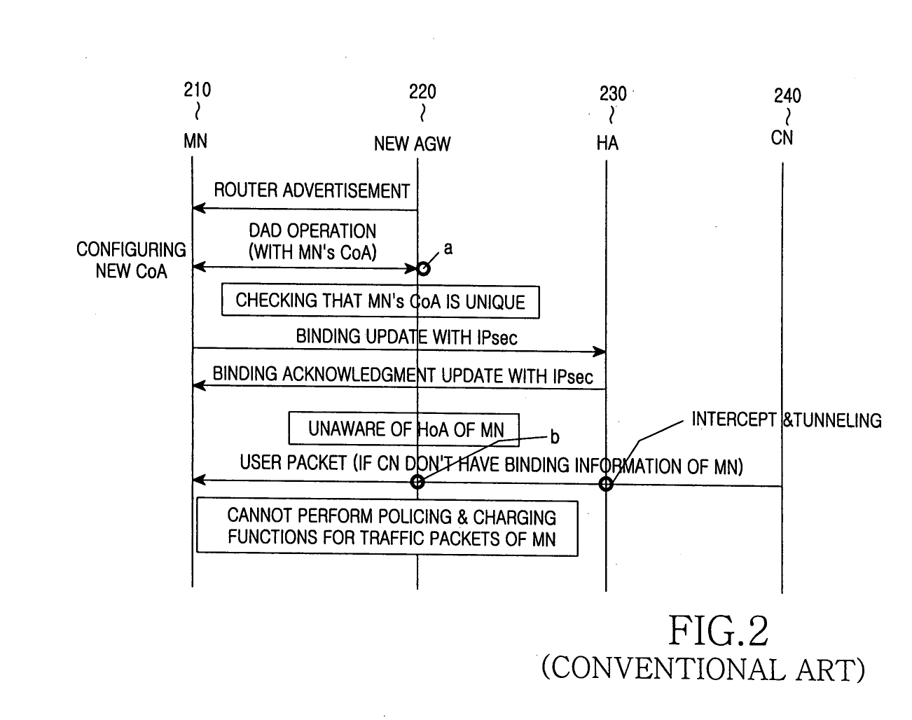

FIG. 3 is a ladder diagram illustrating a process of home address recognition using duplicated address detection according to an exemplary embodiment of the present invention;

FIG. 4 is a flow diagram illustrating operation of an MN according to an exemplary embodiment of the present invention;

FIG. 5 is a flow diagram illustrating operation of an AGW according to an exemplary embodiment of the present invention;

FIG. 6 is a block diagram illustrating constructions of an MN and an AGW according to an exemplary embodiment of the present invention; and

FIG. 7 is a diagram illustrating an extended neighbor solicitation message according to an exemplary embodiment of the present invention.

Throughout the drawings, the same drawing reference numeral will be understood to refer to the same elements, features, and structures.

### DETAILED DESCRIPTION OF THE PREFERRED EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An apparatus and method for home address recognition in a mobile communication system according to exemplary embodiments of the present invention is now described.

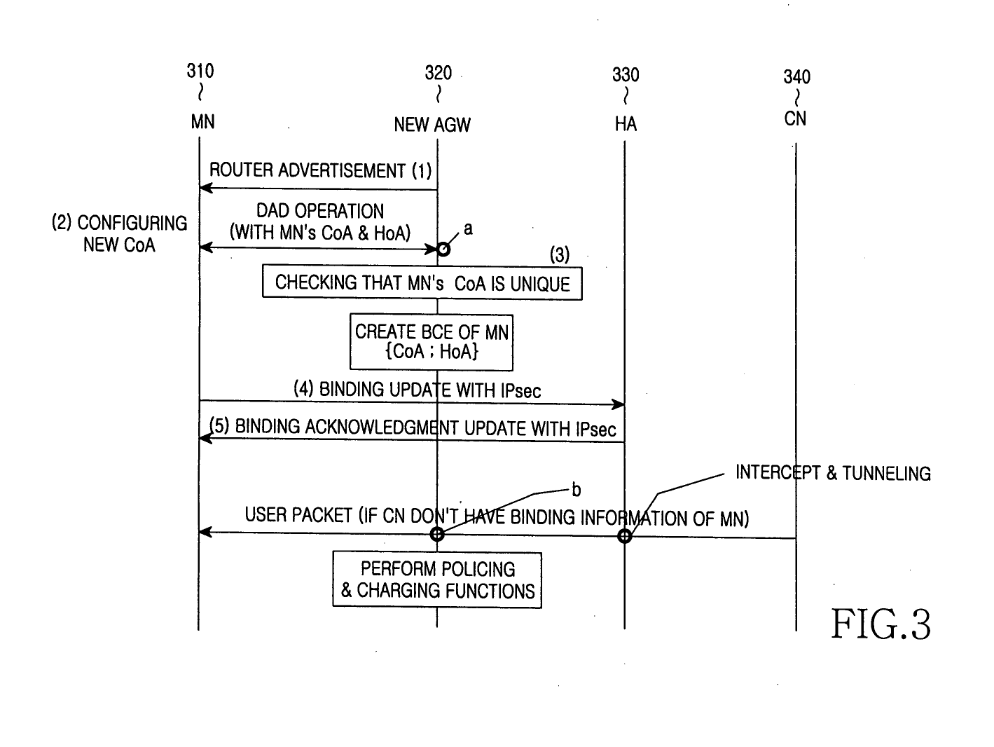

FIG. 3 is a ladder diagram illustrating a process of home address recognition using Duplicated Address Detection (DAD) according to an exemplary embodiment of the present invention.

In FIG. 3, a process of sending a notification of an HoA of an MN 310 to an AGW 320 using a message used for DAD when mobile IPv6 is applied in a 3GPP LTE communication system is described as follows.

An MN 310 moving to a new AGW 320 or a newly booted MN 310 receives an advertisement message (Router Advertisement) from the AGW 320 in step 1. The Router Advertisement includes a network prefix of the AGW 320.

The MN 310 configures a new Care-of Address (nCoA) using the network prefix in step 2.

The MN 310 performs DAD operation with the AGW 320 to check that the CoA is unique in step 3. In an exemplary embodiment of the present invention, the MN 310 modifies a neighbor solicitation message when performing the DAD operation and forwards an HoA of the MN 310 to the AGW 320.

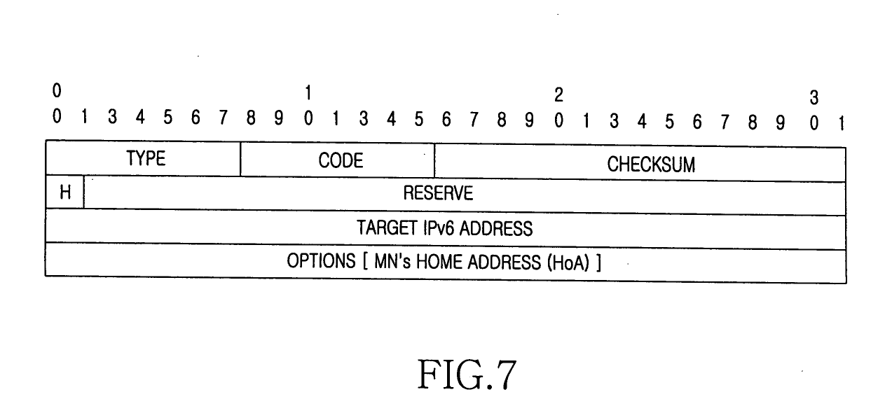

As shown in FIG. 7, an “H” field is added to the neighbor solicitation message used to forward the HoA in the present invention. The “H” field is a newly added flag and represents that the neighbor solicitation message includes the CoA and the HoA of the MN 310 according to an exemplary embodiment of the present invention.

In FIG. 7, an “MN's Home Address (HoA)” field represents an HoA of the MN 310. This is a newly added field and is used for policing and charging functions for the MN 310. For reference, “Target IPv6 address” is an nCoA of the MN 310. The AGW 320 creates a binding cache entry using the HoA and the CoA, recognizes the HoA of the MN 310 using binding cache information, and then uses the HoA to reflect the policing and charging functions for the MN 310.

The neighbor solicitation message substitutes for an existing neighbor solicitation message while performing an HoA transmission function of an exemplary embodiment of the present invention together.

After successfully performing the DAD operation, the MN 310 performs a binding update process for a Home Agent (HA) 330 and a Correspondent Node (CN) 340.

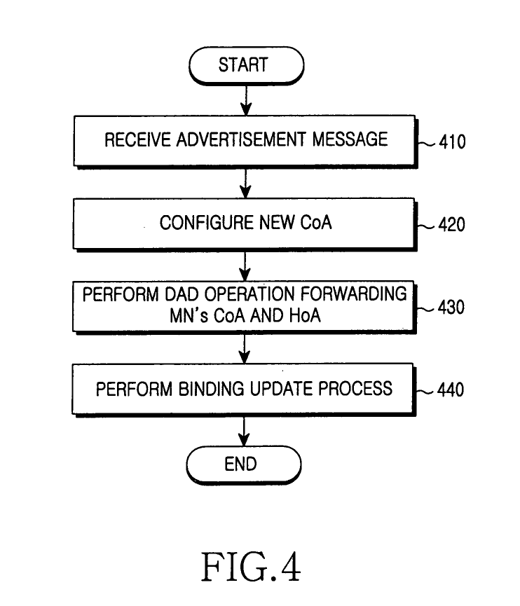

FIG. 4 is a flow diagram illustrating operation of an MN according to an exemplary embodiment of the present invention.

Referring to FIG. 4, if the MN identifies the movement to a new area after receiving an advertisement message (step 410) or receives an advertisement message (step 410) after being booted, the MN creates an nCoA using a network prefix that is included in the advertisement message in step 420.

The MN performs DAD operation forwarding a CoA and an HoA with an AGW in step 430. That is, the HoA is included in a neighbor solicitation message and is transmitted to the AGW.

If successfully performing the DAD operation, the MN performs binding update processes with an HA and a CN in step 440 and then terminates the operation according to an exemplary embodiment of the present invention. The binding update process with the CN may not be performed according to need.

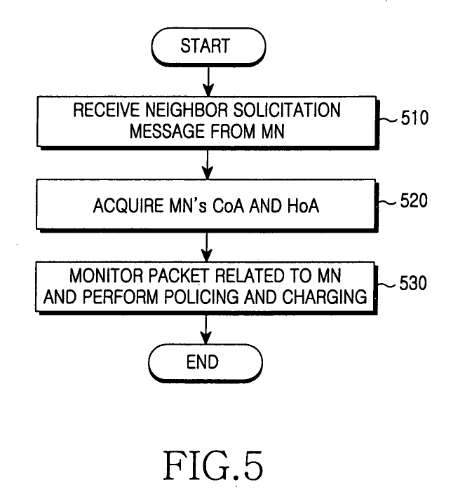

FIG. 5 is a flow diagram illustrating operation of an AGW according to an exemplary embodiment of the present invention.

Referring to FIG. 5, the AGW receives a neighbor solicitation message from an MN in step 510. In step 520, the AGW acquires MN's HoA and CoA when identifying information for notification of inclusion of the MN's HoA in the neighbor solicitation message. The AGW monitors a packet related to the MN and performs policing and charging functions for the MN in step 530.

Then, the AGW terminates the operation according to an exemplary embodiment of the present invention.

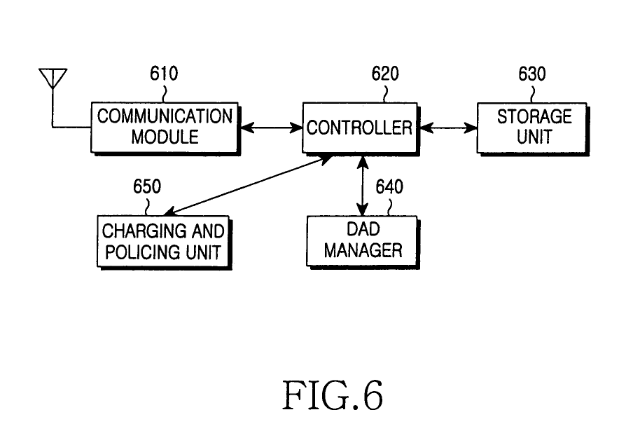

FIG. 6 is a block diagram illustrating constructions of an MN and an AGW according to an exemplary embodiment of the present invention.

A description of the construction of the MN is made with reference to FIG. 6. A communication module 610 is a module for communicating with another node and includes an RF processing module and a baseband processing module. The RF processing module changes an RF signal received through an antenna into a baseband signal and provides the baseband signal to the baseband module. The RF processing module changes a baseband signal from the baseband module into an RF signal so that it can be transmitted over the air and transmits the RF signal through the antenna.

A controller 620 performs basic processing and control of the MN. For example, the controller 620 performs processing and control for data communication and, in addition to a general function, controls a DAD manager 640 to perform DAD operation including an MN's HoA according to an exemplary embodiment of the present invention.

A storage unit 630 performs a function of storing a program for controlling general operation of the apparatus and temporary data generated during execution of the program.

When the DAD manager 640 identifies movement to a new area after receiving an advertisement message by the control and provision information of the controller 620 or receives an advertisement message after booted, the DAD manager 640 creates an nCoA using a network prefix of the advertisement message, allows the CoA to be included in a neighbor solicitation message together with the HoA of the MN, and then transmits the MN's CoA and HoA to the AGW. For reference, the MN does not include a charging and policing unit 650.

Regarding the above-described construction, the controller 620 can perform a function of the DAD manager 640. These are separately constructed and shown in order to distinguish and describe respective functions in the present invention. Thus, when a product is actually realized, the product can be constructed so that the controller 620 can control all of the functions of the DAD manager 640. Alternately, the product can be constructed so that the controller 620 can control only part of them.

A description of the construction of the AGW is made with reference to FIG. 6. A communication module 610 is a module for communicating with another node and includes a wired processing module, an RF processing module, and a baseband processing module. The RF processing module changes an RF signal received through an antenna into a baseband signal and provides the baseband signal to the baseband module. The RF processing module changes a baseband signal from the baseband module into an RF signal so that it can be actually transmitted over air and transmits the RF signal through the antenna. The wired processing module changes a wired signal received via a wired path into a baseband signal and provides the baseband signal to the baseband module. The wired processing module changes a baseband signal from the baseband module into a corresponding wired signal so that it can be actually transmitted over air and transmits the wired signal via a wired path connected.

A controller 620 performs basic processing and control of the apparatus. For example, the controller 620 performs processing and control for data communication and in addition to a general function, acquires an MN's HoA and uses the acquired HoA at the time of reflecting charging and policing, if controlling a DAD manager 640 to perform DAD operation with an MN according to an exemplary embodiment of the present invention.

A storage unit 630 performs a function of storing a program for controlling general operation of the apparatus and temporary data generated during execution of the program.

The DAD manager 640 acquires and provides the MN's HoA and CoA to the charging and policing unit 650, if performing DAD operation with the MN by the control and provision information of the controller 620.

The charging and policing unit 650 monitors forwarding of a packet related to the MN and reflects the monitored result at the time of performing charging and policing functions, using the MN's HoA and CoA provided by the DAD manager 640.

Regarding the above-described construction, the controller 620 can perform functions of the DAD manager 640 and the charging and policing unit 650. These are separately constructed and shown in order to distinguish and describe respective functions in the present invention. Thus, when a product is actually realized, the product can be constructed so that the controller 620 can control all of the functions of the DAD manager 640 and the charging and policing unit 650. Alternately, the product can be constructed so that the controller 620 can control only part of them.

When mobile IPv6 is applied in a 3GPP LTE mobile system, exemplary embodiments of the present invention can provide an MN's HoA to an AGW during DAD operation, and thus allow the AGW to perform charging and policing for the MN.

While exemplary embodiments of the invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. A method for transmitting a Home Address (HoA) of a Mobile Node (MN) in a mobile communication system, the method comprising the steps of:
receiving an advertisement message in the MN;
acquiring a network prefix from the advertisement message;
checking whether a situation of the MN is consistent with a first situation;
creating a first address if the situation is consistent with the first situation; and
transmitting a message comprising the first address, a second address, and information for notification of inclusion of the second address to a network.

2. The method of claim 1, wherein the first situation is a situation where the MN is booted or a situation where the MN receives a network prefix different from an existing network prefix.

3. The method of claim 1, wherein the first address is a Care-of Address (CoA).

4. The method of claim 1, wherein the second address is a Home Address (HoA).

5. The method of claim 1, wherein the message comprising the first address, the second address, and the information is a neighbor solicitation message.

6. A mobile node (MN) for transmitting an HoA in a mobile communication system, the MN comprising:
a communication module for communicating with another node;
a controller for receiving an advertisement message through the communication module, acquiring a network prefix, checking whether a situation of the MN is consistent with a first situation, creating a first address if the situation is consistent with the first situation, and transmitting a message comprising the first address, a second address, and information for notification of inclusion of the second address to a network; and
a storage unit for storing the first address and the second address and providing a work space to the controller.

7. The mobile node of claim 6, wherein the first situation is a situation where the MN is booted or a situation where the MN receives a network prefix different from an existing network prefix.

8. The mobile node of claim 6, wherein the first address is a CoA.

9. The mobile node of claim 6, wherein the second address is an HoA.

10. The mobile node of claim 6, wherein the message comprising the first address, the second address, and the information is a neighbor solicitation message.

11. A method for acquiring an HoA in an Access GateWay (AGW) in a mobile communication system, the method comprising the steps of:
receiving a message from an MN;
acquiring a first address and a second address from the message if discovering information for notification of inclusion of the second address in the message; and
creating a binding cache mapping the first address and the second address.

12. The method of claim 11, further comprising the steps of:
monitoring a packet related to the MN using the first address and the second address of the binding cache; and
applying the monitored result in charging and policing for the MN.

13. The method of claim 12, wherein the first address is a CoA.

14. The method of claim 12, wherein the second address is an HoA.

15. The method of claim 12, wherein the message is a neighbor solicitation message.

16. An Access Gate Way (AGW) for acquiring an HoA in a mobile communication system, the AGW comprising:
a communication module for communicating with another node;
a controller for receiving a message from an MN through the communication module, acquiring a first address and a second address from the message if discovering information for notification of inclusion of the second address from the message, and creating a binding cache mapping the first address and the second address; and
a storage unit for storing the binding cache and providing a work space to the controller.

17. The AGW of claim 16, wherein the controller monitors a packet related to the MN using the first address and the second address of the binding cache and applies the monitored result in charging and policing for the MN.

18. The AGW of claim 16, wherein the first address is a CoA.

19. The AGW of claim 16, wherein the second address is an HoA.

20. The AGW of claim 16, wherein the message is a neighbor solicitation message.

21. A system for transmitting/receiving an HoA in a mobile communication system, the system comprising:
an MN for receiving an advertisement message, acquiring a network prefix, checking whether a present situation is consistent with a first situation, creating a first address if the present situation is consistent with the first situation, and transmitting a message comprising the first address, a second address, and information for notification of inclusion of the second address; and
an AGW for receiving the message, acquiring the first address and the second address if discovering the information for the notification of the inclusion of the second address in the message, and creating a binding cache mapping the first address and the second address.

22. The system of claim 21, wherein the first situation is a situation where the MN is booted or a situation where the MN receives a network prefix different from an existing network prefix.

23. The system of claim 21, wherein the AGW monitors a packet related to the MN using the first address and the second address of the binding cache and applies the monitored result in charging and policing for the MN.

24. The system of claim 21, wherein the first address is a CoA.

25. The system of claim 21, wherein the second address is an HoA

26. The system of claim 21, wherein the message is a neighbor solicitation message.
